(19) United States
(12) Patent Application Publication
(10) Pub. No.: US 2004/0030507 A1
(43) Pub. Date: Feb. 12, 2004

(54) Remote monitoring method of structure

(76) Inventor: Kwang- Woo Jung, Pusan (KR)

Correspondence Address: STAAS & HALSEY LLP, SUITE 700, 1201 NEW YORK AVENUE, N.W., WASHINGTON, DC, 20005, US

(21) Appl. No.: 10/333,593

(22) PCT Filed: Dec. 3, 2000
(86) PCT No.: PCT/KR00/01401

(30) Foreign Application Priority Data
Jul. 24, 2000 (KR) 2000-42355

(51) Int. Cl. G01M 5/00

(52) U.S. Cl. 702/42; 73/786; 340/665

(57) ABSTRACT

Disclosed is a remote monitoring method which is capable of continuously sensing and checking amounts of deformation or amounts of inclination variation of respective unit structures such as tunnels, bridges, large buildings and so on and rapidly carrying out a safety diagnosis for the corresponding structure with the deformation and inclination variation amount data to thereby display the safety diagnosis result on two-dimensional or three-dimensional moving picture screen, whereby an unexpected collapse of the structure can be previously prevented. The remote monitoring method is capable of sensing deformation values and inclination of respective unit structures caused due to an external pressure on the wall surfaces or columns of the respective unit structures such as bridges, tunnels or large buildings, comparing and analyzing the sensed resulting data and an initially measured data to emulate the compared and analyzed data on two or three-dimensional moving picture screen to thereby determine a safety diagnosis for the structure, whereby the information of the degree of danger of the structure can be in real time transmitted to a monitoring system of the structure and to corresponding government and public offices or the relevant organization.

### TECHNICAL FIELD

The present invention relates to a remote monitoring method of a structure and more particularly, to a remote monitoring method of a structure which is capable of continuously sensing and checking an amount of deformation or an amount of inclination variation of respective unit structures such as tunnels, bridges, large buildings and so on and rapidly carrying out a safety diagnosis for the corresponding structure with the resulting data to thereby display the safety diagnosis result on two or three-dimensional moving picture screen, whereby an unexpected collapse of the structure can be previously prevented.

### BACKGROUND ART

Generally, when a large structure is newly constructed or temporarily constructed, a safety test for checking the stress intensity of a framework and an amount of variation due to the inclination of the structure and the external pressure is primarily carried out for the structure, in consideration of the external force such as earth pressure and water pressure applied to the structure according to the state and height of the ground.

Conventionally, the safety test for the structure that is constructed for a long period of time has been intermittently carried out, such that it is very difficult to accurately diagnose the deformation or inclination of the structure caused due to the errors of the design or construction. On the other hand, even if problems contained in the structure are found, the constructed structure should be destroyed, which results in the generation of an economic loss.

In addition, if the structure is constructed even in the state where the precise safety diagnosis for the structure is not carried out due to the short construction period, the structure may be inclined due to the external impact or the ground subsidence, which results in the occurrence of serious safety accidents such as crack, collapse and the like.

### DISCLOSURE OF THE INVENTION

Accordingly, it is an object of the present invention to provide a remote monitoring method of a structure which is capable of sensing deformation values and inclination of respective unit structures caused due to an external pressure on the wall surfaces or columns of the respective unit structures such as bridges, tunnels or large buildings, comparing and analyzing the sensed resulting data and an initially measured data to emulate the compared and analyzed data on two or three-dimensional moving picture screen to thereby determine a safety diagnosis for the structure,

whereby the information of the degree of danger of the structure can be in real time transmitted to a monitoring system of the structure and to corresponding government and public offices or the relevant organization.

To accomplish this and other objects of the present invention, there is provided a remote monitoring method of a structure, which comprises the steps of:

installing a plurality of controllers to which two-axle inclination sensors sensing the configuration of the ground or the state of the ground on which respective unit structures are positioned are attached on the wall surfaces or columns of the respective unit structures to thereby measure amounts of deformation and degrees of inclination of the respective unit structures and building a data base with the resulting data in respective unit structure control units and an Internet server;

converting the values of deformation and the variation values of the inclination on the wall surfaces or the columns sensed by the two-axle inclination sensors attached on the plurality of controllers into a digital signal to thereby transmit the digital signal to the respective unit structure control units via a power line modem, a balanced-to-unbalanced transmission line or a small output radio modem connected to the respective controllers;

comparing and analyzing initially measured data of the respective unit structures that are built as the data base and the values of deformation and the variation values of the inclination on the wall surfaces or the columns of the respective unit structures inputted by the two-axle inclination sensors in the respective unit structure control units to thereby transmit the resulting data to the Internet server via Internet or a public communication telephone network;

carrying out an emulation in the Internet server for the amounts of variation and the degrees of inclination of the respective unit structures, based upon the real-time measured data, the analysis data and the initially measured data received from the respective unit structure control units, on two or three-dimensional moving picture screen according to programming to thereby determine safety diagnoses of the respective unit structures and transmitting the safety diagnoses result to monitoring systems installed in the respective unit structure control units and the output of necessary steps and the degree of danger to corresponding government and public offices or the relevant organization via the Internet or the public communication telephone network in real time;

and transmitting the signal receiving data by periods at the Internet server to the two-axle inclination sensors and the respective unit structure control units, respectively, to thereby check whether a system operates or not.

In this case, the controllers to which the two-axle inclination sensors are attached convert various kinds of signals inputted from the sensors into the digital signals adequate for the transmission through the Internet or the public communication telephone network,

thereby transmitting and receiving the digital signals to/from the respective unit structure control units via the power line modem, the balanced-to-unbalanced transmission line or the small output radio modem.

It is desirable that the respective unit structures are, for example, bridges, tunnels or large multiple-purpose buildings having frequent calls by a large number of users.

Each of the monitoring systems installed in the respective unit structure control units displays a mode discriminating unit composed of a safety mode, a compensation mode, a warning mode, an avoiding mode and an error mode in accordance with the amounts of deformation and the variation amounts of the inclination of the respective unit structures and the operations of the sensors and a display unit displaying a corresponding display lamp, a warning sound, a sensing position, a sensing time and so on according to the corresponding mode.

### BRIEF DESCRIPTION OF THE DRAWINGS

FIG. 1 is a flowchart illustrating the operation orders of a remote monitoring method of a structure according to the present invention;

FIG. 2 is a block diagram illustrating the construction according to the present invention; and

FIG. 3 is a block diagram illustrating the operating modes and the display unit for each mode of the monitoring system of the present invention.

### BEST MODE FOR CARRYING OUT THE INVENTION

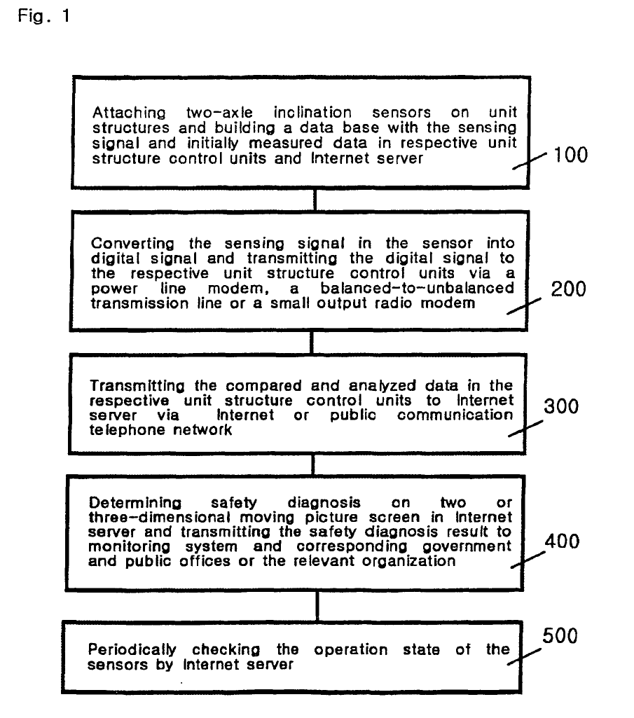

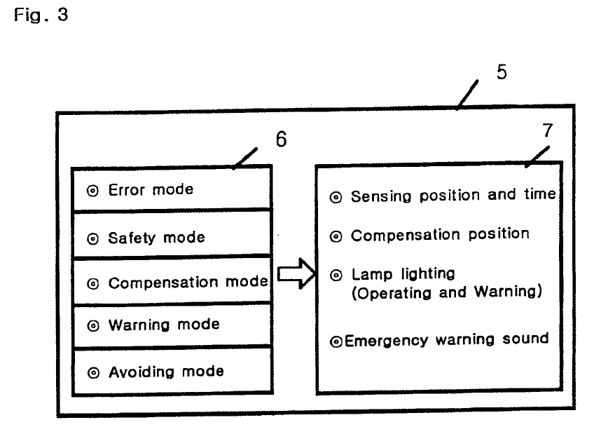

Now, an explanation of the operation orders of a remote monitoring method of a structure according to the present invention will be in detail discussed with reference to FIGS. 1 to 3.

FIG. 1 is a flowchart illustrating the operation orders of a remote monitoring method of a structure according to the present invention and

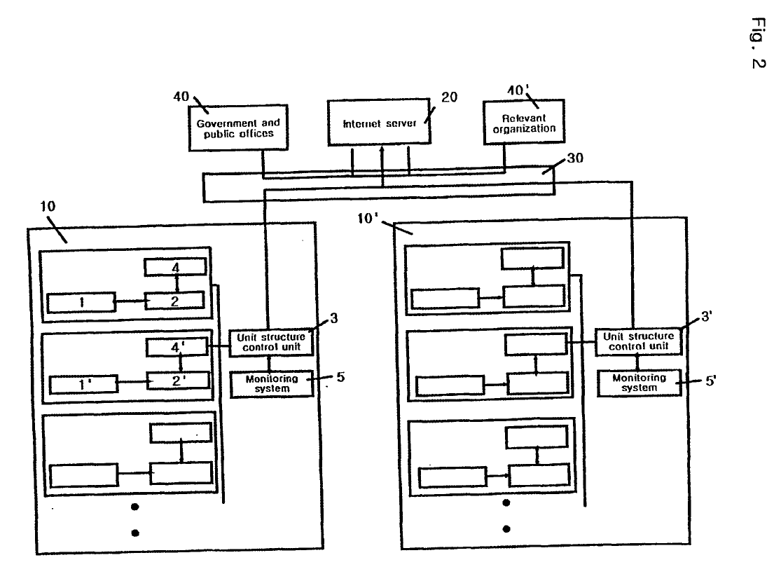

FIG. 2 is a block diagram illustrating the construction according to the present invention.

As shown, there is provided a remote monitoring method of a structure according to the present invention, which comprises:

the step (100) of installing a plurality of controllers 2 and 2′ to which two-axle inclination sensors 1 and 1′ sensing the configuration of the ground or the state of the ground on which respective unit structures 10 and 10′ are positioned are attached on the wall surfaces or columns of the respective unit structures 10 and 10′ to thereby measure amounts of deformation and degrees of inclination of the respective unit structures and building a data base with the resulting data in respective unit structure control units 3 and 3′ and an Internet server 20;

the step (200) of converting the values of deformation and the values of variation of the inclination on the wall surfaces or the columns sensed by the two-axle inclination sensors 1 and 1′ attached on the plurality of controllers 2 and 2′ into digital signals to thereby transmit them to the respective unit structure control units 3 and 3′ via a power line modem, a balanced-to-unbalanced transmission line or a small output radio modem 4 connected to the respective controllers 2 and 2′;

the step (300) of comparing and analyzing initially measured data of the respective unit structures 10 and 10′ that are built as the data base and the values of deformation and the values of variation of the inclination on the wall surfaces or the columns of the respective unit structures 10 and 10′ inputted by the two-axle inclination sensors 1 and 1′ in the respective unit structure control units 3 and 3′ to thereby transmit the resulting data to the Internet server 20 via Internet or a public communication telephone network 30;

the step (400) of carrying out an emulation in the Internet server 20 for the amount of variation and the degree of inclination of the respective unit structures 10 and 10′, based upon the real-time measured data, the analysis data and the initially measured data received from the respective unit structure control units 3 and 3′, on two or three-dimensional moving picture screen according to programming to thereby determine safety diagnoses of the respective unit structures 10 and 10′ and transmitting the safety diagnoses result to monitoring systems 5 installed in the respective unit structure control units 3 and 3′ and the output of necessary steps and the degree of danger to corresponding government and public offices 40 or the relevant organization 40′ via the Internet or the public communication telephone network 30 in real time;

and the step (500) of transmitting the signals receiving data by periods at the Internet server 20 to the two-axle inclination sensors 1 and 1′ and the respective unit structure control units 3 and 3′, respectively, to thereby check whether a system operates or not.

In more detail, on the wall surfaces or the columns of the respective unit structures 10 and 10′ having frequent calls by a large number of users, the two-axle inclination sensors 1 and 1′ are attached, each of which is adapted to sense the amount of variation of the inclination as an analog or digital voltage in accordance with the inclination having the impedance within the range of 90 varied by the variation of a force-applied electrode on the basis of gravity.

Thereby, the controllers 2 and 2′ convert the values of deformation and the values of the variation of inclination of the respective unit structures 10 and 10′ into the digital values accessible to the Internet or the public communication and transmit the digital values to the respective unit structure control units 3 and 3′ via the power line modem, the balanced-to-unbalanced transmission line or the small output radio modem 4.

The values of deformation and the values of variation of inclination of the respective unit structures 10 and 10′ are compared and analyzed with the initially measured data stored as the data base, and the compared and analyzed data is transmitted in real time to the Internet server 20 via the Internet or the public communication telephone network 30 such as a control office.

The Internet server 20 carries out the safety diagnoses for the respective unit structures 10 and 10′ by displaying the real-time measured data and the compared and analyzed data on the two or three-dimensional moving picture screen according to the programming.

Also, the Internet server 20 outputs the necessary steps for the respective unit structures 10 and 10′ in accordance with the degree of danger of the structures 10 and 10′, transmits the safety diagnoses result to the monitoring systems 5 installed in the respective unit structure control units 3 and 3′, and transmits the degree of danger to the corresponding government and public offices 40 or the relevant organization 40′ in the real time, whereby the safety diagnoses for the plurality of unit structures 10 and 10′ can be continuously carried out in the remote places, at the same time.

The monitoring system 5, which is emulated on the two or three-dimensional moving picture by the Internet server 20 and operates depending upon the degree of danger of each of the unit structures 10 and 10′,

is composed of a mode dividing unit 6 that divides the degree of danger into the safety mode, the compensation mode, the warning mode, the avoiding mode and the error mode checking whether the two-axle inclination sensors 1 and 1′ operate or not by referring for example to the following table [1] showing the allowable displacement limit of each structure for safety diagnosis.

The monitoring system is further composed of a display unit 7 that displays the operating lamp, the warning lamp, the warning sound and the sensing position and time of the two-axle inclination sensor where the corresponding danger is generated in accordance with the corresponding mode.

As a consequence, the safety states of the respective unit structures 10 and 10′ can be immediately checked, thereby utilizing the respective unit structures 10 and 10′ in a more stable manner.

TABLE 1
<Allowable displacement limit of each structure>

| Displacement Angle | Allowable Limit of Structure |
|---|---|
| 1/100 | Expected damage limit of general structure |
| 1/200˜1/300 | Visible collapse limit of high building |
| 1/400˜1/500 | Expected first crack limit on partition wall and |
| | expected working difficulty limit of elevated crane |
| 1/600 | Safety limit for building where |
| | crack is not allowable |
| 1/700˜1/800 | Danger limit of framework having material |
| 1/900˜1/1,000 | Mechanical base difficulty limit sensitive to |
| | ground subsidence |

Also, the Internet server 20 transmits the signals periodically checking the operating states of the two-axle inclination sensors 1 and 1′ installed in the respective unit structures 10 and 10 and the respective unit structure control units 3 and 3′ to the respective unit structure control units 3 and 3′ via the Internet or the public communication telephone network 30, thereby controlling and adjusting the operations of the two-axle inclination sensors 1 and 1′.

### INDUSTRIAL APPLICABILITY

As clearly appreciated from the foregoing, a remote monitoring method of a structure according to the present invention has some advantages that two-axle inclination sensors that are attached on the wall surfaces or the columns of respective unit structures in a remote place transmit amounts of deformation and amounts of variation of inclination of the respective unit structures to a single Internet server providing two or three-dimensional moving picture via Internet or public communication telephone network, thereby transmitting the degree of danger of the respective unit structures to monitoring systems, corresponding government and public offices or the relevant organization in the real time, such that it is convenient to continuously check the safety diagnoses for the respective unit structures, that the signal capable of periodically checking the operation state of the sensors is transmitted, thereby providing the system having a high reliability, such that large-building collapse accidents can be previously prevented and a loss of lives can be minimized, and that the safety diagnoses for the respective unit structures in the remote places can be at the same time carried out through the Internet server, such that the management cost and the labor cost can be remarkably reduced.

What is claimed is:

1. A remote monitoring method of a structure, comprising the steps of:
installing a plurality of controllers to which two-axle inclination sensors sensing the configuration of the ground or the state of the ground on which respective unit structures are positioned are attached on the wall surfaces or columns of said respective unit structures to thereby measure amounts of deformation and degrees of inclination of said respective unit structures and building a data base with the resulting data in respective unit structure control units and an Internet server;
converting the values of deformation and the values of variation of the inclination on the wall surfaces or the columns sensed by said two-axle inclination sensors attached on said plurality of controllers into digital signals to thereby transmit the digital signals to said respective unit structure control units via a power line modem, a balanced-to-unbalanced transmission line or a small output radio modem connected to said plurality of controllers;
comparing and analyzing initially measured data of said respective unit structures that are built as the data base and the values of deformation and the values of variation of the inclination on the wall surfaces or the columns of said respective unit structures inputted by said two-axle inclination sensors in said respective unit structure control units to thereby transmit the resulting data to said Internet server via Internet or a public communication telephone network;
carrying out an emulation in said Internet server for the amounts of variation and the degrees of inclination of said respective unit structures, based upon the real-time measured data, the analysis data and the initially measured data received from said respective unit structure control units, on two or three-dimensional moving picture screen according to programming to thereby determine safety diagnoses of said respective unit structures and transmitting the safety diagnoses result to monitoring systems installed in said respective unit structure control units and the output of necessary steps and the degree of danger to corresponding government and public offices or the relevant organization via said Internet or said public communication telephone network in real time; and
transmitting the signal receiving data by periods at said Internet server to said two-axle inclination sensors and said respective unit structure control units to thereby check whether a system operates or not.

2. The method of claim 1, wherein said controllers to which said two-axle inclination sensors are attached converts various kinds of signals inputted from said two-axle inclination sensors into the digital signals adequate for the transmission through said Internet or the public communication telephone network, thereby transmitting and receiving the digital signals to/from said respective unit structure control units via said power line modem, said balanced-to-unbalanced transmission line or said small output radio modem.

3. The method of claim 1, wherein said respective unit structures are bridges, tunnels or large multiple-purpose buildings having frequent calls by a large number of users.

4. The method of any of claims 1 to 3, wherein each of said monitoring systems installed in said respective unit structure control units comprises a mode dividing unit composed of a safety mode, a compensation mode, a warning mode, an avoiding mode and an error mode in accordance with the amounts of deformation and the variation amounts of the inclination of said respective unit structures and the operation of said two-axle inclination sensors and a display unit displaying a corresponding display lamp, a warning sound, a sensing position and a sensing time according to the corresponding mode.
